(19) United States
(12) Patent Application Publication
(10) Pub. No.: US 2011/0002396 A1
(43) Pub. Date: Jan. 6, 2011

(54) Reference Frames Compression Method for A Video Coding System

(75) Inventor: Yuri Ivanov, Dublin (IE)

Correspondence Address: MARSH, FISCHMANN & BREYFOGLE LLP, 8055 East Tufts Avenue, Suite 450, Denver, CO, 80237, US

(73) Assignee: LINEAR ALGEBRA TECHNOLOGIES LIMITED, Dublin (IE)

(21) Appl. No.: 12/866,660

(22) PCT Filed: Feb. 6, 2009
(86) PCT No.: PCT/EP09/51415

§ 371 Date: Sep. 15, 2010

(30) Foreign Application Priority Data
Feb. 8, 2008 (GB) 0802310.3

(51) Int. Cl. H04N 7/26

(52) U.S. Cl. 375/240.24

(57) ABSTRACT

The present application relates to apparatus for compression of the reference frames in the video coding system, reducing the memory requirements by 50%. The invention allows for compression and allocation of a frame in a memory so that parts of it can be accessed without the need for retrieval and decompression of the entire compressed frame. The invention is ideally suited for the compression of block-structured image data that is utilized in many video coding systems.

### FIELD

The present application relates to a method for storing reference frames in a video coding system. More particularly, the present application outlines a system for compressing a reference frame when storing it in a reference frame buffer in such a way that parts of the reference frame may be accessed without the need for retrieving and decompressing the entire compressed structure from the buffer.

### BACKGROUND

It is a fundamental aspect in video coding systems that temporal redundancy in video imagery can be removed by exploiting motion predictive coding. For that purpose, video coding standards including for example MPEG-4, H.263, H.261 and H.264 utilize an internal memory buffer to store previously reconstructed (reference) frames. Subsequent frames may be generated with reference to the changes that have occurred from the reference frame. The internal memory buffer in which reference frames are stored is frequently referred to as the “reference frames buffer”.

Supporting a certain number of reference frames is one of the limitations in the design of video coding systems because of internal memory requirements for the reference-frame buffer.

A known solution to this fundamental problem is to compress reference frames. In particular, it is possible to compress a reference frame after its reconstruction and store it in the reference frames buffer for subsequent use. When needed, a particular reference frame (or part of it) can be decompressed and employed for the motion predictive coding\decoding.

It will be appreciated that not all methods of data or image compression are suitable for this task. Methods such as Huffman data compression or JPEG image coding are complex by their nature and may demand significant computational resources, especially during the encoding process. Also, these methods provide variable compression rate depending on the amount of spatial redundancy in the encoded data and thus cannot guarantee that compressed structure will fit into the available memory. Finally parts of an encoded image in such methods cannot be accessed without decompression of the whole image. Since modern video coding systems are based on the concept of dividing an image into smaller blocks, called ‘macroblocks’, for encoding, having to decode an entire image to process an individual macroblock can be seen as quite a significant disadvantage.

As a result, the above compression methods are difficult to utilize in video coding systems as a method for reference compression.

Many researchers have attempted to reduce memory requirements for a video coding system. Current approaches to the problem are ranged from relatively simple methods, such as U.S. Pat. No. 5,825,424, where sub-sampling to a lower resolution or truncation of pixel values to a lower precision is used, to complicated techniques such as is described in U.S. Pat. No. 6,272,180, where the Haar block-based 2D wavelet transform is utilized.

For the compression systems mentioned above, achieving a constant compression rate for a reference frame in a video coding system introduces a drift, which reveals itself as a visible temporal cycling in reconstructed picture quality due to losses introduced at the decoding stage. While simple compression methods such as lower resolution sub-sampling, have the advantage of low computational complexity, they suffer from disadvantage of higher drift. Attempts to reduce the drift have lead to the elaboration of the method and therefore a significant increase in complexity, especially at the encoding stage.

### SUMMARY

The present application seeks to reduce memory requirements of the video coding system by exploiting a lossy data compression for reference frames stored in the reference frames buffer. The reference frame storage method presented herein has the advantage of relatively low drift that is particularly suited to hardware implementation within a video coding system. This allows for a system with low computational complexity, low drift and a constant compression rate of 50%. An important aspect is that the compressed reference frame may be accessed and decompressed without a need to retrieve and decompress the entire frame, which makes it particularly suitable for block-structured image data such as, for example, those utilized in video coding systems such as H.264, MPEG-4, H.263.

Accordingly, the present application provides for systems and methods as explained in the detailed description which follows and as set out in the independent claims, with advantageous features and embodiments set forth in the dependent claims.

### BRIEF DESCRIPTION OF THE DRAWINGS

The present application will now be described with reference to the accompanying drawings in which:

FIG. 1 illustrates an organization of a reference frames memory in the video coding system that may exploit the compression apparatus of the present application,

FIG. 2 illustrates how blocks in a reference frame encoded by a system of the present application correspond to byte pairs in the compressed memory,

FIG. 3 illustrates a Pattern Selection stage of the encoding process of the present application,

FIG. 4 illustrates a Byte Pair Encoding process of the encoding algorithm of the present application,

FIG. 5 illustrates a decoding process as set forth in this application,

FIG. 6 illustrates an exemplary format of a byte pair that may be employed by the compression apparatus of FIGS. 3-5,

FIG. 7 illustrates which samples in an original block are extracted in encoding process of FIG. 3 to form colour samples in the compressed byte pairs,

FIG. 8 illustrates reconstruction patterns used for the encoding\decoding methods of the present application with reference to FIG. 7,

FIG. 9 illustrates exemplary equations are used in the encoding and decoding process of FIGS. 3-5.

### DETAILED DESCRIPTION OF THE DRAWINGS

The embodiments disclosed below were selected by way of illustration and not by way of limitation. Indeed, many minor variations to the disclosed embodiments may be appropriate for a specific actual implementation.

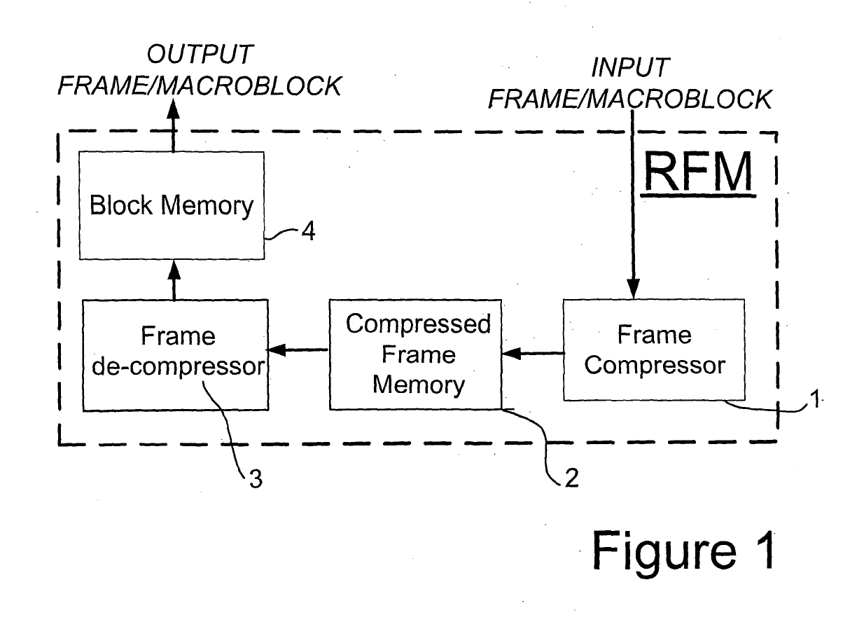

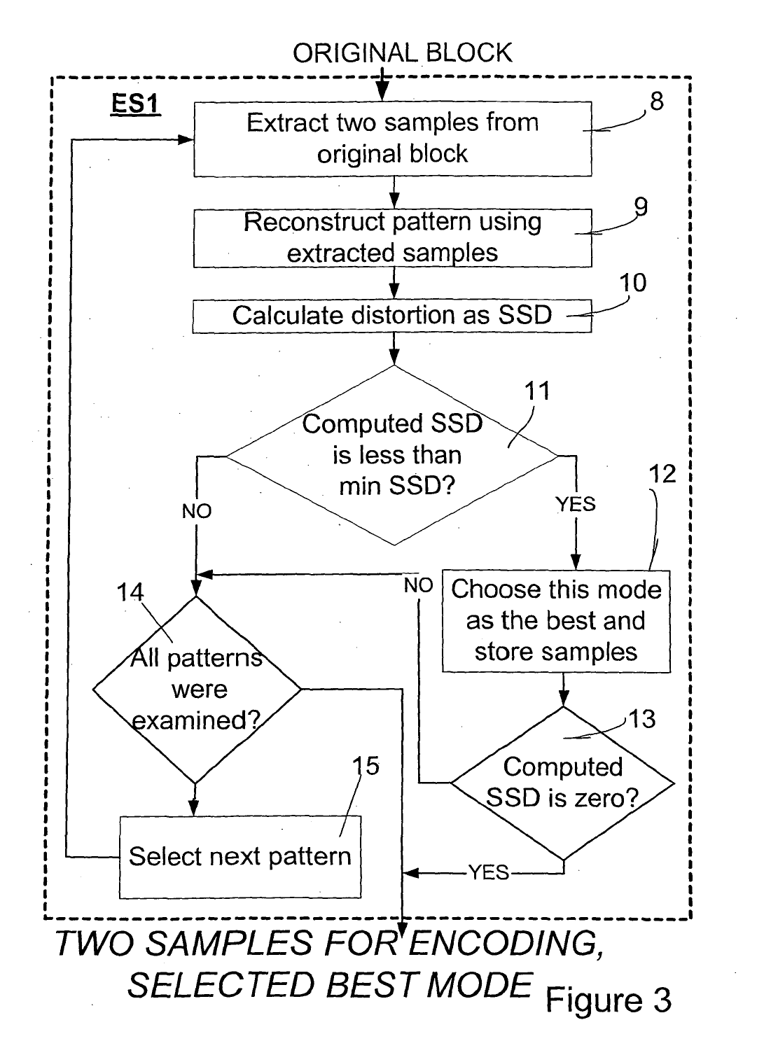

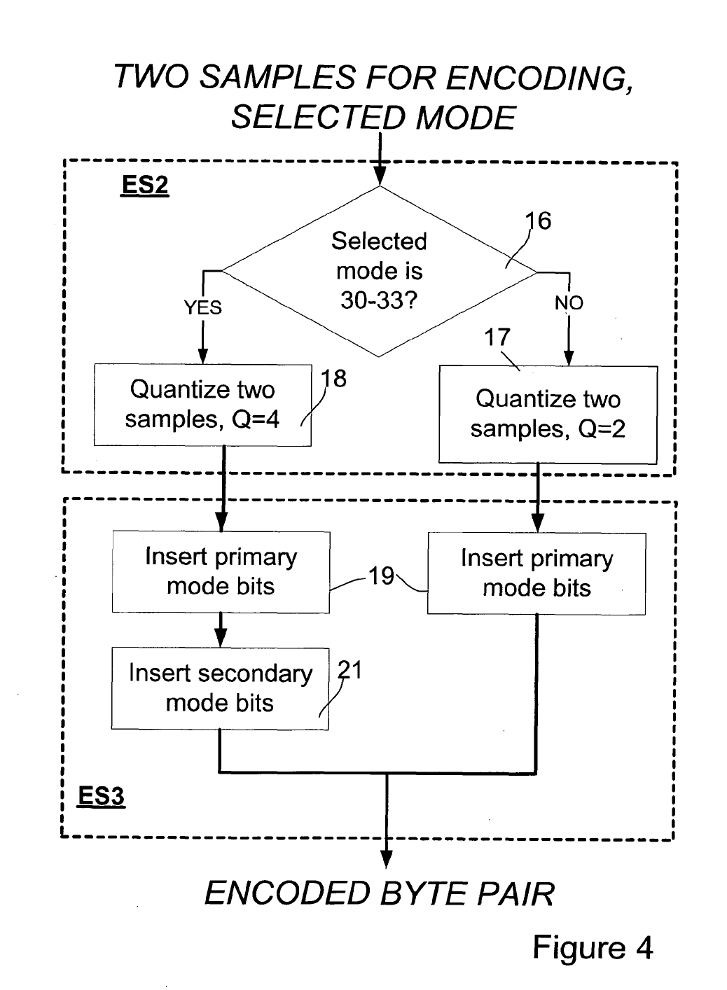

A general structure of a reference frames memory (RFM) in the video coding system that may exploit the compression apparatus of the present application, as shown in FIG. 1, comprises a frame compressor 1, which uses the compression algorithm shown in FIGS. 3 and 4 and described below.

The frame compressor 1 processes a frame as a sequence of blocks of data 6 from a frame 5 and produces a corresponding sequence of blocks with a reduced block size 7. Thus in the illustrated example, each incoming block of 2×2 bytes is reduced into a block of 2×1 bytes (a byte pair) allowing the frame to be stored in a reduced size memory.

The reduction of block size is made by analysing the distribution of values within the data block and selecting a distribution pattern of two data values from the four data values of the block which may be used to represent the block. The distribution pattern is selected such that the optimum distribution pattern is selected from a plurality of pre-defined patterns. Once the optimum distribution pattern and the corresponding two data values have been selected for each 2×2 block, the pattern and data values are then encoded into a byte pair providing a compressed structure for the 2×2 block.

Byte pairs are stored in compressed frame memory 2. When a reference frame or part of a reference frame is required, a frame decompressor 3 decompresses the required byte pairs 7 into 2×2 reconstructed blocks. Reconstructed blocks are stored in the block memory 4 and eventually form the de-compressed frame or required part of the frame, which may be employed as a reference frame or part of a reference frame and may be employed conventionally within the video coding system. It will be appreciated that the term video coding system is used generally herein and may refer to a video encoding or a video decoding system.

Typically, reference frames are stored in the video coding systems in YUV colour space. The present application is suitable for but not limited to YUV. In YUV image compression each colour component (Y, U or V) has a fixed length, for example eight bits. Suitably, the encoding and decoding processes described herein are performed separately for each colour component, i.e. the Y, U and V are processed separately.

Quantization introduced in the compression process means that the colour samples of original block before encoding are not equal to the samples of a reconstructed block after decoding. However, as with other image compression techniques, this application exploits the fact that some losses are almost imperceptible to the human observer.

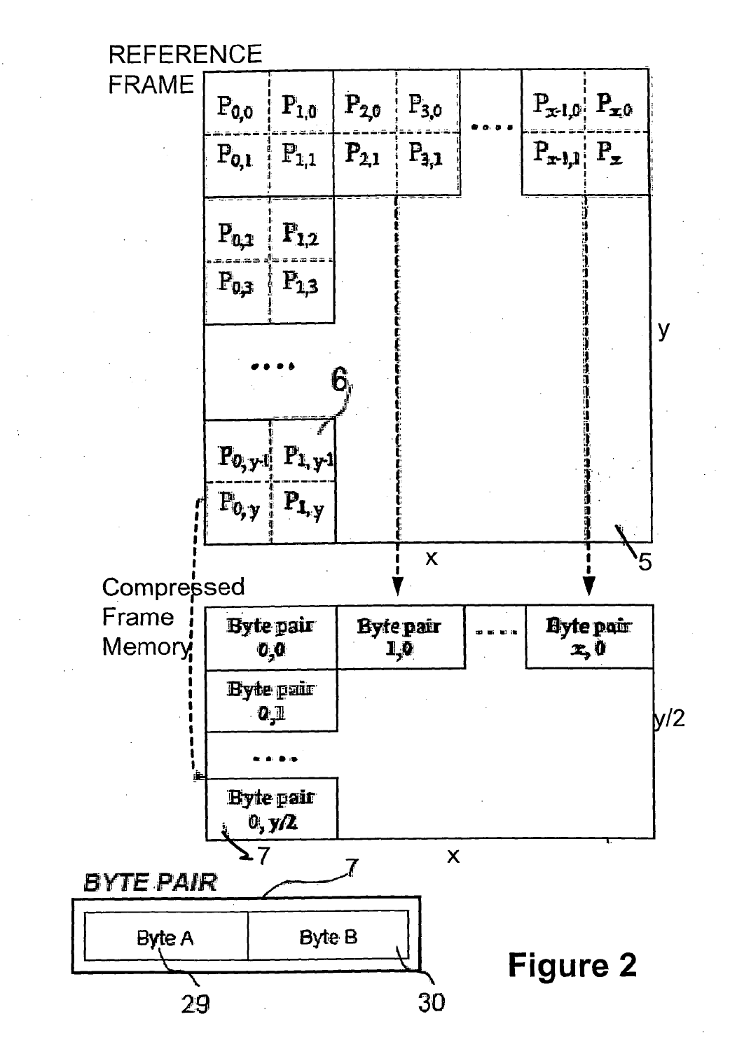

As illustrated in FIG. 2, an advantage of the invention is that access to individual compressed byte pairs within a frame buffer with compression is as simple as access to a corresponding 2×2 block in a frame buffer without compression. In the exemplary arrangement, the byte pairs 7 are aligned horizontally along the x-image axis in the compressed frame memory 2 such that the dimension of the compressed structure is the same for the x axis as for the original frame, but the dimension of the y axis data is halved. Thus for every 2×2 block 6 of original frame 5 there is a corresponding byte pair 7 in the compressed frame memory 2. Such an organization of compressed memory allows for easy access to a particular 2×2 sub-block without the need to decompress the entire frame, since the x axis index value for locating the first byte of the byte pair in the compressed structure is the same as locating that for locating the first block in the 2×2 sub block in the uncompressed frame and the y axis index in the compressed structure is half that of the y axis index in the uncompressed structure. Moreover, the addressing and compression\decompression may be inherent to the hardware for accessing the frame buffer so that the rest of the video coder is ignorant of the compression.

The encoding process will now be described with reference to FIGS. 3 and 4, in which the encoding process is performed in two stages—namely of Pattern Decision ES1, as shown in FIG. 3, and Byte Pairs Encoding which consists of Quantization ES2 and Mode bits insertion ES3, as shown in FIG. 4.

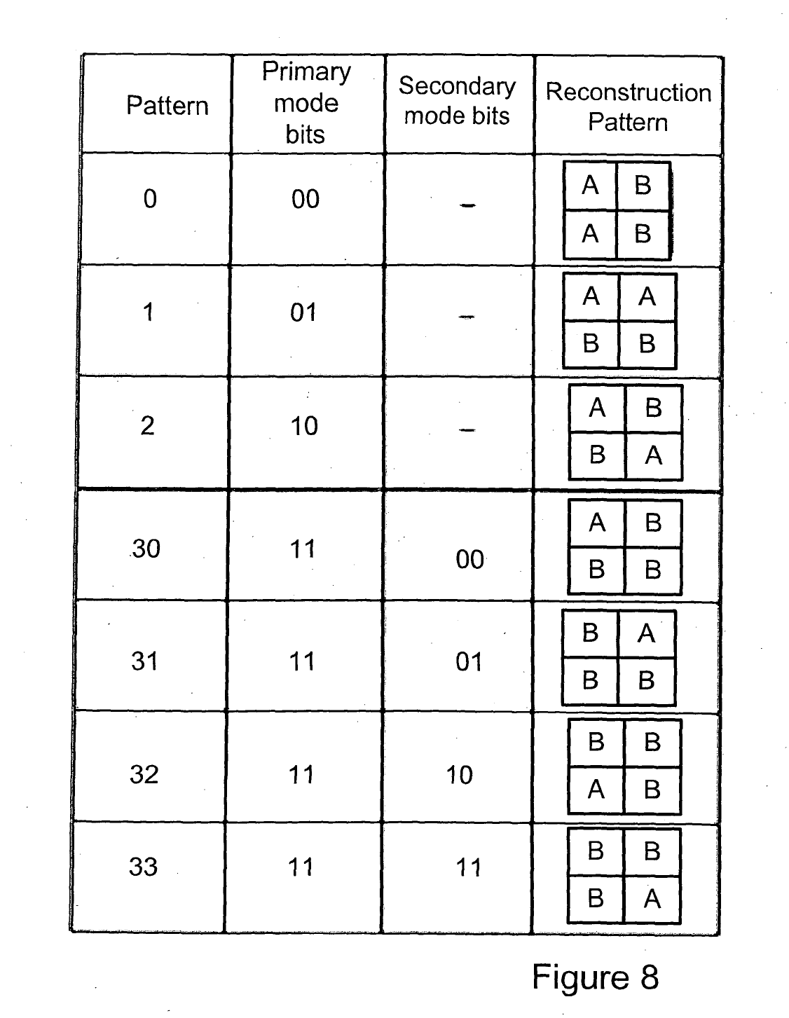

During Pattern Decision ES1, possible losses from decompression are estimated through calculation of the distortion for each of seven pre-defined reconstruction patterns as shown in FIG. 8. The pattern that results in minimum distortion of the original block is selected as the optimum pattern for Byte Pairs Encoding (ES2 and ES3). It will be appreciated that employing a 2×2 block size means that a hardware implementation of the calculation is possible without undue complexity.

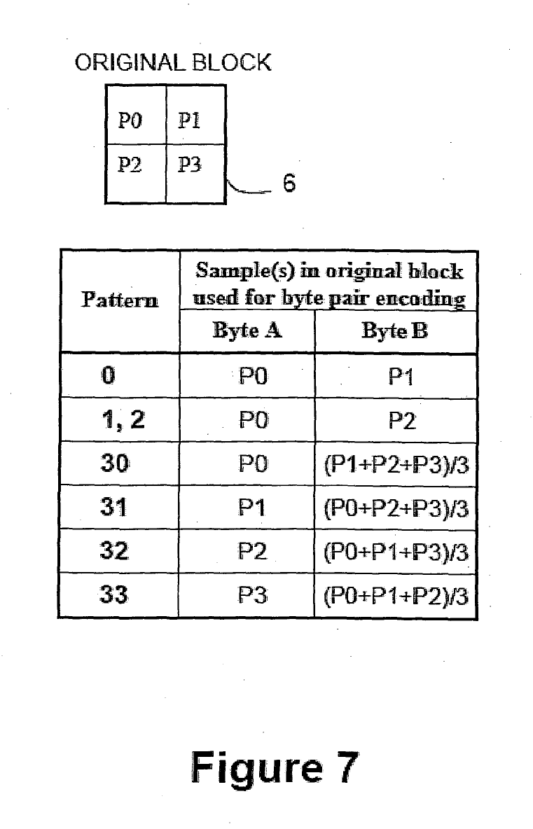

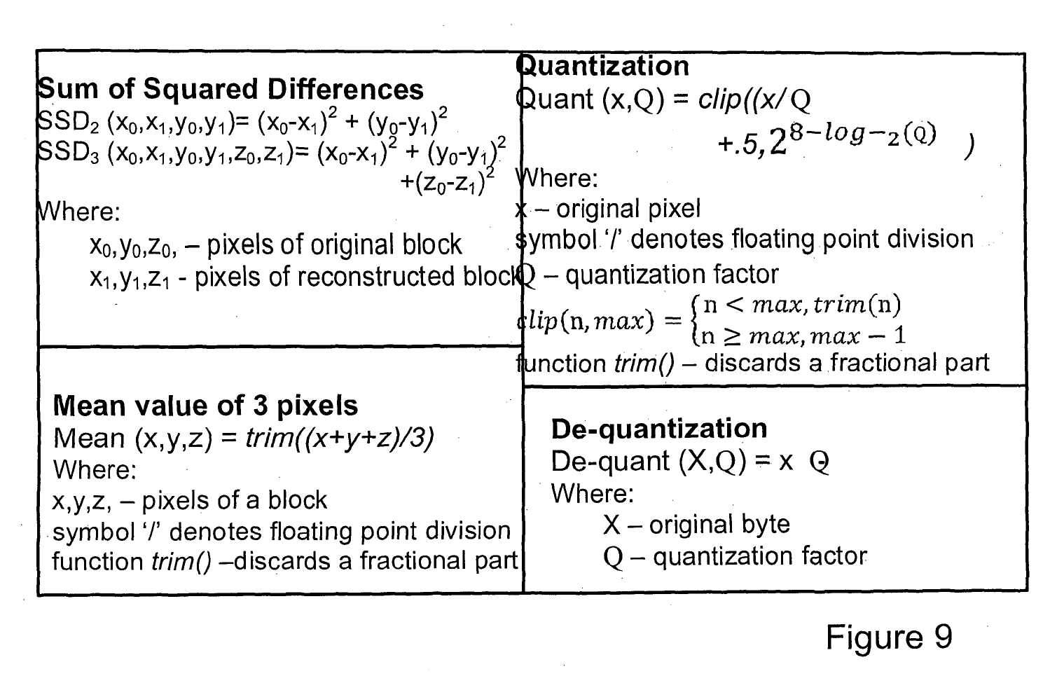

First, during ES1 two colour samples are selected 8 as shown in FIG. 7. Then a first reconstruction pattern is created 9 and distortion between the original 2×2 block and the reconstructed block is calculated 10. The distortion may be computed using a number of different methods including for example a Sum of Squared Differences (SSD) function as illustrated in FIG. 9, or as a Sum of Absolute Differences (SAD) function. The SSD function may produce better results but require greater computation that the SAD function. The method will be explained further with reference to employing the SSD function. In the method, the SSD function for a currently examined pattern is compared with the minimum SSD found for previously examined patterns 11. If the newly computed SSD is less than the minimum SSD, then the corresponding pattern is temporarily selected as the preferred pattern for Byte Pairs Encoding and current SSD is set as the minimum SSD, 12.

This process may be repeated for each pattern, when all patterns have been examined 14, the currently identified preferred pattern is selected as the final pattern for the block. The selected samples passed for Quantization ES2. If not all patterns were examined so far, then next pattern is selected 15. During the preferred pattern selection process in the event 13 that the distortion is measured as being at or below a minimum threshold (e.g. zero) for a pattern, this pattern may be selected as the final preferred pattern and distortion calculations for the remaining patterns negated as unnecessary.

Statistically, certain patterns are more likely to be identified as the preferred pattern, accordingly the encoding speed may be improved by examining the patterns in a most appropriate statistical order, namely when patterns are examined ranging from the most probable to the least probable. The examination order of the patterns illustrated in FIG. 7 is 0, 1, 2, 30, 31, 32 and 33. Although seven patterns are described in FIG. 7, it will be appreciated that this number may be reduced, for example to three, depending on requirements. As illustrated, Pattern 0 is examined first and pattern 7 is examined last respectively.

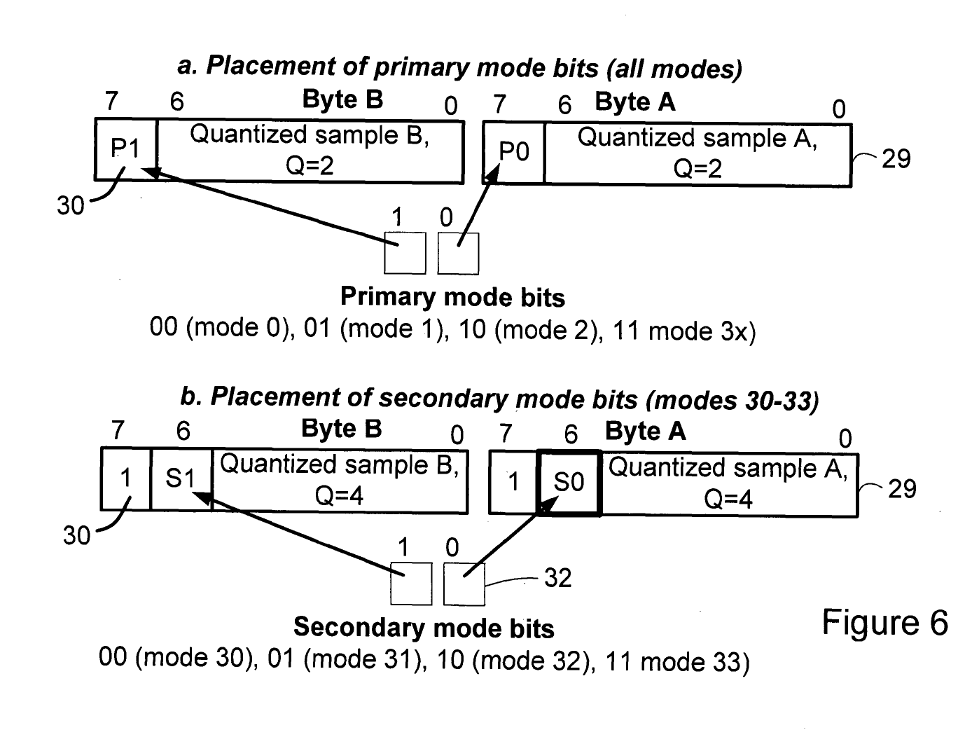

The Byte Pairs Encoding process is illustrated in FIG. 4. It involves quantization ES2 of two original colour samples and inserting ES3 of 1 or 2 mode bit(s) that represent the pattern number in the place of the highest order bit(s) in the each byte of byte pair as shown in FIG. 6.

During the quantization ES2, the number of bits needed to represent the colour component is reduced to allow for the pattern to be encoded within the compressed data. The data values may be reduced from 8 bits to 7 or 6 bits, depending on the selected pattern. Thus if the selected pattern is 3×16, then colour samples are quantized to 6 bits 18. For patterns 0-2, colour samples are quantized to 7 bits 17. The quantization is performed by eliminating the least significant bit or bits, e.g. by dividing the colour value by a quantization coefficient (2 or 4) as shown in FIG. 9. To reduce quality losses, a quantization formula with floating point division followed by rounding and clipping shown in FIG. 9 may be employed.

After the quantisation process has been completed, there is space in the byte pairs for mode bits insertion ES3 in FIG. 4. This mode bit insertion involves the insertion of primary mode bits 19 and, for modes 3× insertion 21 of secondary mode bits. The mode bits serve to identify the preferred pattern to be used during reconstruction.

Specific mode bits placement is illustrated in FIG. 6. For each byte 29 and 30 in the byte pair 7, primary mode bits 31 are always inserted on the place of the highest bits of a byte. For modes 0-2, bits 6 to 0 in each byte pair will represent the quantized colour. For modes 30-7 the secondary bits 32 are inserted in place of 6^{th} bit in each byte 29 and 30 of a byte pair 7. The quantized colour samples are located in bits 5 to 0 having a length of 6 bits respectively.

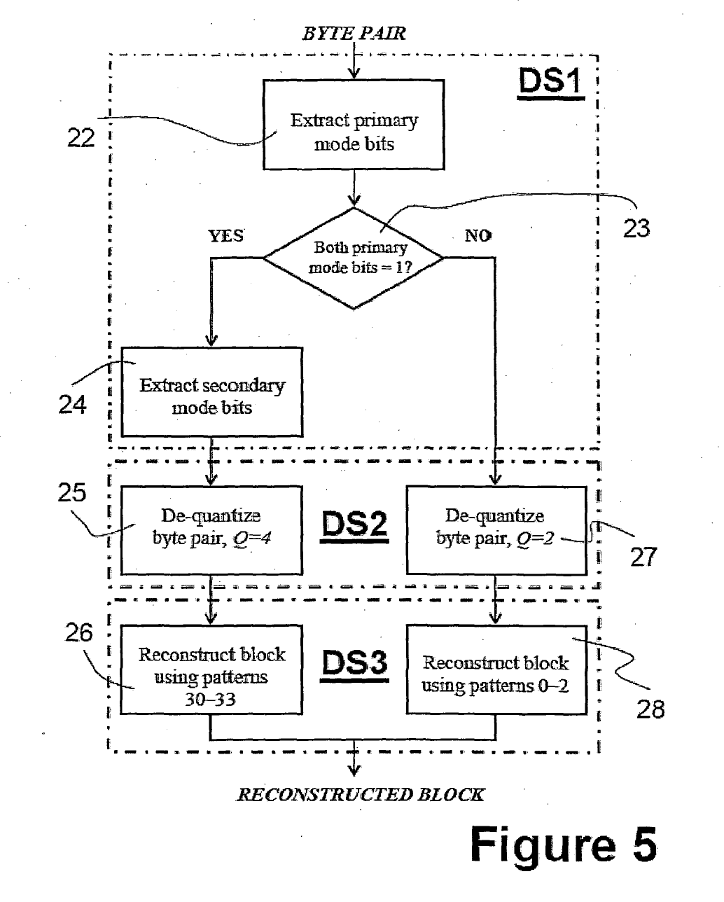

The decoding process is illustrated in FIG. 5. It consists of mode bits extraction DS1 and determining the pattern number, the byte pair de-quantization DS2 and 2×2 block reconstruction DS3.

During DS1 primary bits 31 are extracted first 22, then if they both are ‘1’ 23, which indicates that 3× mode has been used, the secondary mode bits 32 are also extracted 24.

Then, the colour samples are de-quantized 25, 27, based on the primary mode bits. During DS2 the number of bits needed to represent the colour component is increased to 8 by multiplying a quantized value by de-quantization coefficient (left shifting by one or two bits), as shown in FIG. 9. The de-quantization coefficient can be 2 or 4 depending on the mode. For modes 0-2, de-quantization coefficient 2 is selected 27, while for modes 30-7 de-quantization coefficient is 4, as in 25.

Finally, at the DS3 step, the 2×2 blocks are reconstructed 26, 28 using the mode bits 31 and 32 (for 3× modes) as a pattern number plus de-quantized colour samples obtained previously on the step DS2, as shown in FIG. 8.

FIG. 7 illustrates which positions in original 2×2 block 6 are used to obtain the colour samples during encoding at stage ES1, 8. For modes 0-2 these may be two colours or averaged values. For modes 30-7, the byte B 30 in the byte pair 7 may be computed as mean value of three colour samples, as shown in FIG. 9. Other values such as the median value may also be employed.

FIG. 8 shows the reconstruction patterns used by the method namely how two colour samples are used to form a 2×2 four colour samples block. For modes 0-2, each byte of the byte pair is sub-sampled into two colours, either in horizontal direction (pattern 0), vertical direction (pattern 1) or as horizontal swap (pattern 2). For modes 30-7, byte A 29 is used to form one colour sample, while byte B 30 forms three colour samples. Secondary mode bits 32 in that case determine a position of byte A 29 in the 2×2 reconstructed block.

FIG. 9. illustrates exemplary equations that may be used by the method. The Sum of Squared Differences (SSD) is used in ES1 10 for the distortion calculation. The mean value of three pixels is used in ES1 8 to obtain a colour samples 29 and 30. The quantization formula is used during encoding ES2 at quantization stage 17, 18. The de-quantization formula is used at decoding stage DS3 25, 27.

Whilst the present application has been described with reference to an exemplary embodiment, these are not to be taken as limited and it will be appreciated that a variety of alterations may be made without departing from the spirit or the scope of the invention as set forth in the claims which follow.

1. A method for storing a reference frame in a reference frame buffer comprising the steps of:
dividing the reference frame into a sequence of data blocks comprising four data values; the method comprising the following steps performed on individual data blocks of the sequence:
determining a suitable encoding pattern for an individual block, wherein the encoding pattern employs a reduced set of data values and is selected from a predefined set of encoding patterns,
generating a compressed data block comprising the reduced set of data values with an identification of the selected encoding pattern, and storing the compressed data block in the reference frame buffer.

2. A method for compressing a data block according to claim 1, wherein the reduced set of data values comprises two data values.

3. A method according to claim 2, wherein a first value in the reduced set of data values is one of the data values from the individual data block.

4. A method according to claim 3, wherein the second value of the reduced set of data values is selected from:
a) another data value from the individual block, or
b) the average of other data values in the individual block.

5. A method according to any preceding claim, wherein each data block in the sequence comprises a block of 2x axis elements by 2 y axis elements.

6. A method according to any preceding claim, wherein the data values are eight bits in length.

7. A method according to any preceding claim, wherein the selection of the encoding pattern is made by determining the encoding pattern of the predefined set of encoding patterns with the least loss.

8. A method according to any preceding claim, wherein the reduced set of data values are shorter in length than the data values of the data block being compressed.

9. A method according to any preceding claim, wherein the identification of the selected pattern in the reduced data block comprises at least one mode bit in each data value of the reduced data block.

10. A method according to claim 9, wherein the at least one mode bit is placed in place of the highest order bits of each data value of the reduced data block.

11. A method according to claim 9, wherein the at least one mode bit is placed in place of the lowest order bits of each data value of the reduced data block.

12. A method of compressing a reference frame according to any preceding claim, wherein the frame comprises three colour components and the individual components are compressed separately.

13. A method of compressing an image according to claim 12, wherein the components are Y, U and V components.

14. A video codec employing the method of anyone of claims 1 to 12 to store a reference frame.

15. A video coding system comprising a reference frame buffer, the video coding system comprising a compression engine for storing a compressed reference frame within the reference frame buffer, wherein the compression engine is configured to group data values of the reference frame to be compressed into data blocks comprising 4 adjoining data values, the compression engine comprising:
a best fit estimator for selecting a reduced set of two data values for each individual data block and an encoding pattern to reconstitute the datablock from the reduced set and
an encoder for encoding the reduced set of data values with an identification of the selected encoding pattern to provide a compressed data block and storing the compressed data block in the reference frame buffer.

16. A video coding system according to claim 15, wherein the data block comprises a block of 2x axis component values by 2 y axis component values.

17. A video coding system according to claim 16 or 17, wherein the length of an individual data value within a reference frame is the same as the length of an individual data value and the identification of the selected encoding pattern within the compressed frame.

18. A video coding system according to anyone of claims 15 to 17, further comprising a decompression engine for retrieving at least one compressed data block from the frame buffer and decompressing the at least one compressed data block when requested by the video coding system.

19. A video coding system having a frame buffer for storing a reference frame in a compressed format comprising a sequence of data blocks, each block comprising two data values embedded with an identification of a predefined encoding pattern, the video coding system comprising a decompression engine the decompression engine being configured to:
a) retrieve a requested data block from the stored sequence of data blocks in the frame buffer,
b) extract the identification of the encoding pattern from the retrieved data block,
c) extract the two data values from the retrieved block, and
d) reconstruct an uncompressed data block by populating a data block of four values with the extracted two data values in accordance with the identified encoding pattern.

20. A video coding system according to claim 19, wherein the reconstructed data block is a block of 2 x axis elements by 2 y axis elements.

21. A video coding system according to anyone of claims 19 to 20, wherein the reduced set of data values are 6 to 7 bits in length and the decompression engine pads the values in the reconstructed block with one or two zeros so that they are 8 bits in length.

22. A video coding system according to anyone of claims 19 to 21, wherein the identification of the selected pattern in the reduced data block comprises one or two mode bits in each data value of the reduced data block.

23. A video coding system according to anyone of claims 19 to 22, wherein the reference frame comprises three component images.

24. A video coding system according to claim 23, wherein the components are Y, U and V components.
